(19) United States
(12) Patent Application Publication
(10) Pub. No.: US 2016/0110691 A1
(43) Pub. Date: Apr. 21, 2016

(54) ACTION PROPOSAL DEVICE

(71) Applicant: DENSO CORPORATION, Aichi (JP)

(72) Inventor: Yasuhiro SHIMIZU, Kariya-city (JP)

(21) Appl. No.: 14/896,880

(22) PCT Filed: May 12, 2014
(86) PCT No.: PCT/JP2014/002486

§ 371 Date: Dec. 8, 2015

(30) Foreign Application Priority Data
Jun. 12, 2013 (JP) 2013-124066

(51) Int. Cl. G06Q 10/10; G06N 99/00

(52) U.S. Cl. CPC G06Q 10/1095; G06N 99/005

(57) ABSTRACT

An action proposal device includes a learning unit learning an acceptable value of an action density of a user based on a past schedule of the user, an available time acquisition unit acquiring an available time of the user in future, a density determination unit determining an action density of the user for a predetermined period including the available time acquired by the available time acquisition unit, and a proposal unit comparing the action density determined by the density determination unit with the acceptable value of the action density, which is learned by the learning unit. The proposal unit determines, corresponding to a comparison result, whether to perform an action proposal for the available time acquired by the available time acquisition unit. When determining to perform the action proposal for the available time, the proposal unit proposes an action that is finishable during the available time of the user.

### CROSS REFERENCE TO RELATED APPLICATION

This application is based on Japanese Patent Application No. 2013-124066 filed on Jun. 12, 2013, the disclosure of which is incorporated herein by reference.

### TECHNICAL FIELD

The present disclosure relates to an action proposal device that proposes an action to a user, and more particularly to an action proposal device that proposes an action appropriate for the pace of the user.

### BACKGROUND ART

There is a known device that references a schedule of a user and provides information in consideration of time available before the next-scheduled activity (refer, for instance, to Patent Literature 1).

When sufficient time is not available before the next scheduled activity, the invention disclosed in Patent Literature 1 does not propose a plan for making a side trip to a place far from a designation in order to reduce the risk of being late for the next scheduled activity.

However, even if sufficient time is available before the next scheduled activity, users do not always think of performing an action before the next scheduled activity. Some users think that scheduling an additional action to be performed before the next scheduled activity will make the schedule of the users excessively tight and inappropriate for the pace of the users.

Nevertheless, when sufficient time is available before the next scheduled activity, conventional technologies propose, for example, that the users make a side trip. Thus, the users are sometimes bothered by such an action proposal.

### PRIOR ART LITERATURES

### Patent Literature

[Patent Literature 1] JP 2007-257168 A

### SUMMARY OF INVENTION

In view of the foregoing difficulties, it is an object of the present disclosure to provide an action proposal device that is capable of proposing an action appropriate for the pace of a user.

According to an aspect of the present disclosure, an action proposal device includes a learning unit, an available time acquisition unit, a density determination unit, and a proposal unit. The learning unit learns an acceptable value of an action density of a user based on a past schedule of the user. The available time acquisition unit acquires an available time of the user in future. The density determination unit determines an action density of the user for a predetermined period including the available time acquired by the available time acquisition unit. The proposal unit compares the action density determined by the density determination unit with the acceptable value of the action density, which is learned by the learning unit. The proposal unit determines, corresponding to a comparison result, whether to perform an action proposal for the available time acquired by the available time acquisition unit. When determining to perform the action proposal for the available time, the proposal unit proposes an action that is finishable during the available time of the user.

According to the above action proposal device, the future available time of the user is acquired. However, an action proposal is not always made for the available time. The present disclosure learns the acceptable value of user's action density and compares the learned acceptable value of action density with the actual user's action density for a predetermined period including the available time acquired by the available time acquisition unit. Based on the result of comparison, the present disclosure determines whether or not to make an action proposal for the available time. Therefore, in a situation where there is available time, when making an action proposal for the available time exceeds the acceptable value of the action density of the user, the action proposal device determines that an action proposal should not be made for the available time. When the action density of the user is not exceeded in a situation where an action proposal is made for the available time, the action proposal device selects an available time slot for which an action proposal may be made, and proposes an action that can be performed during a period of the available time for which the action proposal may be made. This configuration makes it possible to propose an action appropriate for the pace of the user.

### BRIEF DESCRIPTION OF DRAWINGS

The above and other objects, features, and advantages of the present disclosure will become more apparent from the following detailed description made with reference to the accompanying drawings. In the drawings:

FIG. 1 is a diagram illustrating a configuration of a vehicle navigation device to which an action proposal device according to an embodiment of the present disclosure is applied;

FIG. 2 is a flowchart illustrating a process that is performed by a navigation ECU;

FIG. 3 is a diagram illustrating an example of a part of an action history that is updated in step S3 of FIG. 2;

FIG. 4 is a diagram illustrating an example of learning, for instance, an acceptable value of action density;

FIG. 5 is a flowchart illustrating the details of a process performed in step S9 of FIG. 2;

FIG. 6 is a diagram illustrating exemplary conditions for determining a proposed facility in step S10 of FIG. 2;

FIG. 7 is a flowchart illustrating an action proposal process; and

FIG. 8 is a diagram illustrating an example of proposal timing.

### EMBODIMENTS FOR CARRYING OUT INVENTION

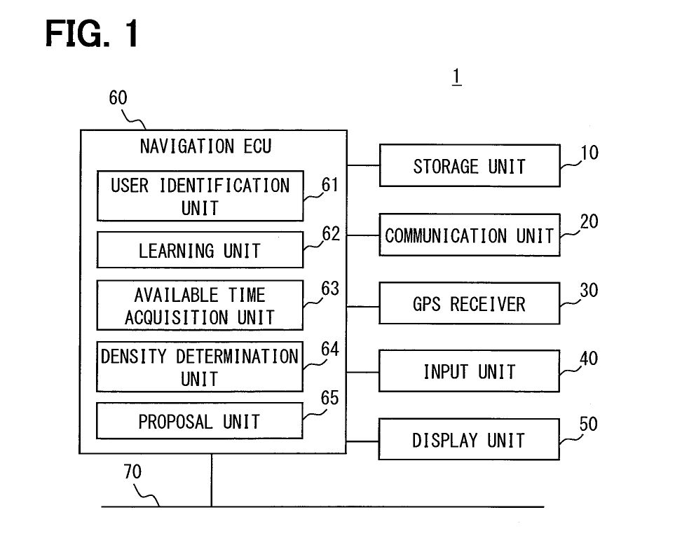

An embodiment of the present disclosure will now be described with reference to the accompanying drawings. In the present embodiment, a vehicle navigation device (hereinafter simply referred to as the navigation device) illustrated in FIG. 1 incorporates the function of an action proposal device according to the present disclosure. The navigation device 1 includes a storage unit 10, a communication unit 20, a GPS receiver 30, an input unit 40, a display unit 50, and a navigation ECU (Electronic Control Unit) 60.

The storage unit 10 stores an action history of a user, an action plan, and an acceptable value of action density. In the present embodiment, the action history of the user includes a travel history of the navigation device 1. When a travel history of the user is successfully acquired from a remote information processing device, the travel history is also included in the action history of the user. Further, even if the present time goes beyond a scheduled time of a previously acquired action plan due to the elapse of time, the previously acquired action plan is included in the action history of the user on the presumption that the user has acted according to the previously acquired action plan.

The storage unit 10 also stores road map data, facility data, and other data necessary for route guidance. The facility data includes the coordinates of facilities, the genres of the facilities, and the names of the facilities.

The communication unit 20 receives various kinds of information by communicating with an external source. The information to be received includes the aforementioned action history and action plan. The action history and action plan are acquired from various information processing devices such as a mobile information processing terminal, a personal computer, and a server. Typical information to be acquired is, for example, a schedule managed by such information processing devices. The communication unit 20 may communicate with the information processing devices either in a wireless manner or in a wired manner.

The GPS receiver 30 receives a signal transmitted from a GPS satellite, and successively determines the coordinates of the current location on the basis of the received signal.

The input unit 40 inputs user identification information that identifies the user. For example, a software keyboard may be generally used as the input unit 40. More specifically, the input unit 40 may be a touch panel that is superposed over the display surface of the display unit 50 and used together with keys laid out and displayed over the display surface. In this instance, the user can input user ID using the touch panel. When the user is to be identified by face recognition, the input unit 40 may include a camera therein.

The input unit 40 is used not only to input the user identification information but also to input various instructions for manipulating the navigation device 1. In order to input such instructions, the input unit 40 includes software switches or mechanical switches.

The display unit 50 displays a road map. The display unit 50 also displays the details of an action that is to be proposed to the user. In addition, the display unit 50 also displays various kinds of information.

The navigation ECU 60 is a computer that includes, for example, a CPU, a ROM, and a RAM (these components are not shown). When the CPU executes a program stored in the ROM while using a temporary storage function of the RAM, the navigation ECU 60 provides read/write control over the storage unit 10, communication control over the communication unit 20, and display control over the display unit 50. Further, the navigation ECU 60 successively acquires the current location determined by the GPS receiver 30 and successively acquires various kinds of information, such as the vehicle speed of the host vehicle, through a CAN (Controller Area Network) 70. Besides, the navigation ECU 60 incorporates a route setup function and a route guidance function. The route setup function is executed to set up a route to a destination. The route guidance function is executed to provide guidance on the route to the destination on the basis of the current location and road map data.

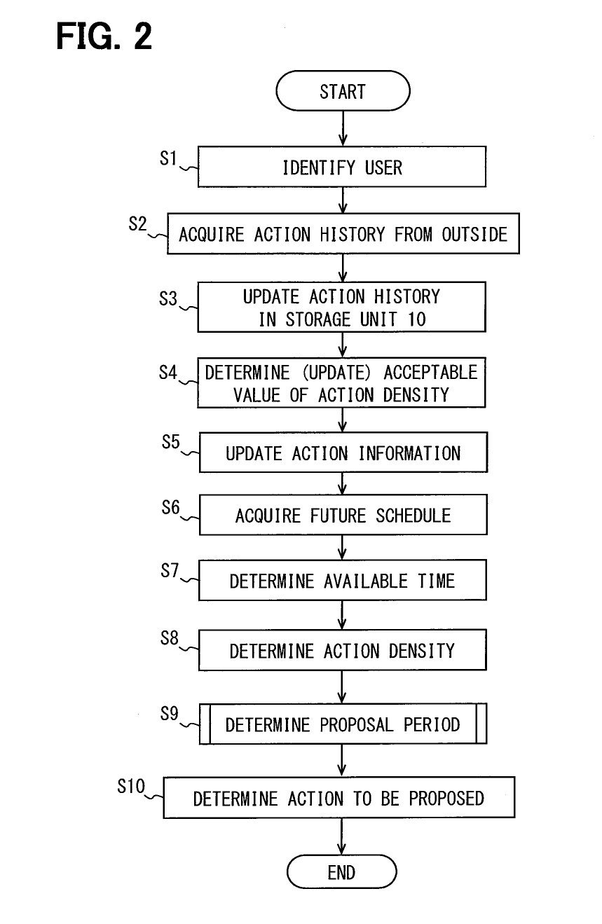

Moreover, as illustrated in FIG. 1, the navigation ECU 60 functions as a user identification unit 61, a learning unit 62, an available time acquisition unit 63, a density determination unit 64, and a proposal unit 65. The functions of these units will now be described with reference to FIG. 2 and the following figures.

The process of FIG. 2 is executed by the navigation ECU 60 when a predetermined execution condition is established. The process may be executed when, for instance, an execution interval has elapsed, an IG is turned off, or the IG is turned on. An alternative is to adopt a certain other execution condition or combine a plurality of different execution conditions.

In step S1, the user identification unit 61 identifies the user. The user is identified by using the user identification information inputted from the input unit 40. Subsequent processing steps are performed with respect to the user identified in step S1. The user may alternatively be identified in advance, separately from the process of FIG. 2.

Subsequently, steps S2 to S5 are performed by the learning unit 62. In step S2, the action history of the user, which is the history of a period between the last execution of step S2 and the present time, is acquired from an external information processing device. In a case where the action history before the last execution of step S2 is still not acquired, that action history before the last execution of step S2 is also acquired. The action history is acquired by communicating with the external information processing device through the communication unit 20. The communication with the external information processing device may be automatically established. An alternative is to acquire a message prompting the user to perform a manual manipulation procedure and acquire the action history on the basis of the manual manipulation procedure performed by the user.

For example, the action history to be acquired may be action information included in a past portion of a schedule managed by the external information processing device. The past portion of the schedule is a partial schedule that is arranged before the present time. Since the user often acts according to the information inputted to the schedule, the action information included in the past portion of the schedule may be acquired as the action history of the user.

The fact that the user inputted the action information to the schedule although the user did not act in compliance with the action information inputted to the schedule signifies that the user at least intended to act in compliance with the action information. The navigation device 1 according to the present embodiment estimates whether or not the user intends to fill an available period in the schedule, and makes an action proposal with respect to the available period that the user intends to fill. Therefore, the action information indicating at least the user's intention to act is worth acquiring as the action history.

As another example of the action history to be acquired, when communication is to be established with a mobile information processing device having a location detection function, the travel history of that mobile information processing device may be acquired as the action history.

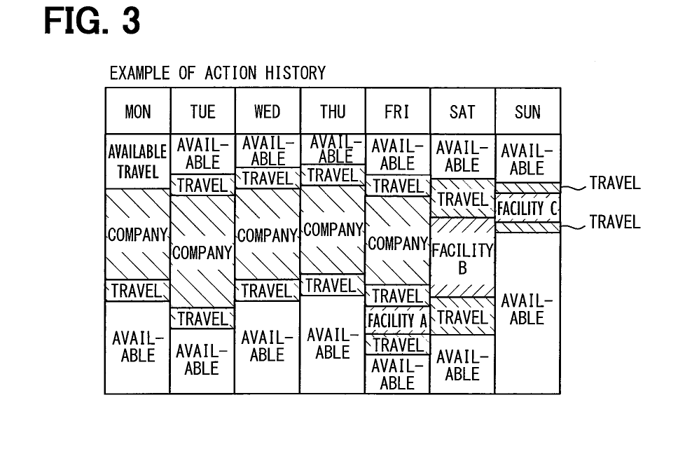

In step S3, the action history stored in the storage unit 10 is updated on the basis of the action history acquired in step S2. The action history stored in the storage unit 10 is updated as needed on the basis of the travel history of the navigation device 1 in addition to the update based on the action history acquired in step S2. FIG. 3 illustrates an example of a part of the action history that is updated in step S3. Shaded portions of FIG. 3 are time slots from which information indicative of user activity is acquired.

In step S4, the acceptable value of action density of the user is determined based on the action history updated in step S3. In a case where the acceptable value of the user's action density is already determined, the determined acceptable value is updated in step S4.

The action density is an index indicating the degree to which the schedule of the user is filled. More specifically, the action density in the present embodiment is represented by the number of going-outs, the period of time of the going-out, and the time of returning home. The larger the number of going-outs, the higher the degree to which the schedule is filled. Therefore, the number of going-outs represents the action density. Similarly, the longer the period of time of going-out, the higher the degree to which the schedule is filled. Therefore, the period of time of going-out also represents the action density. The earlier the time of returning home, the longer the period of time during which the user stays at home. Therefore, the time of returning home also represents the action density. In the present embodiment, the period of time of going-out is divided into travel time and stay time. The reason is that the later-described action proposal is made to propose an action that is to be performed within the travel time permitted by the user.

Each acceptable value is set by adding a predefined margin of the action density to an average value of action density, for instance, an average value of the number of going-outs. As regards the number of going-outs, a numerical value may be predefined for each of a plurality of different periods such as those related to the number of daily going-outs and the number of monthly going-outs. An acceptable value is then set for each of the plurality of different periods.

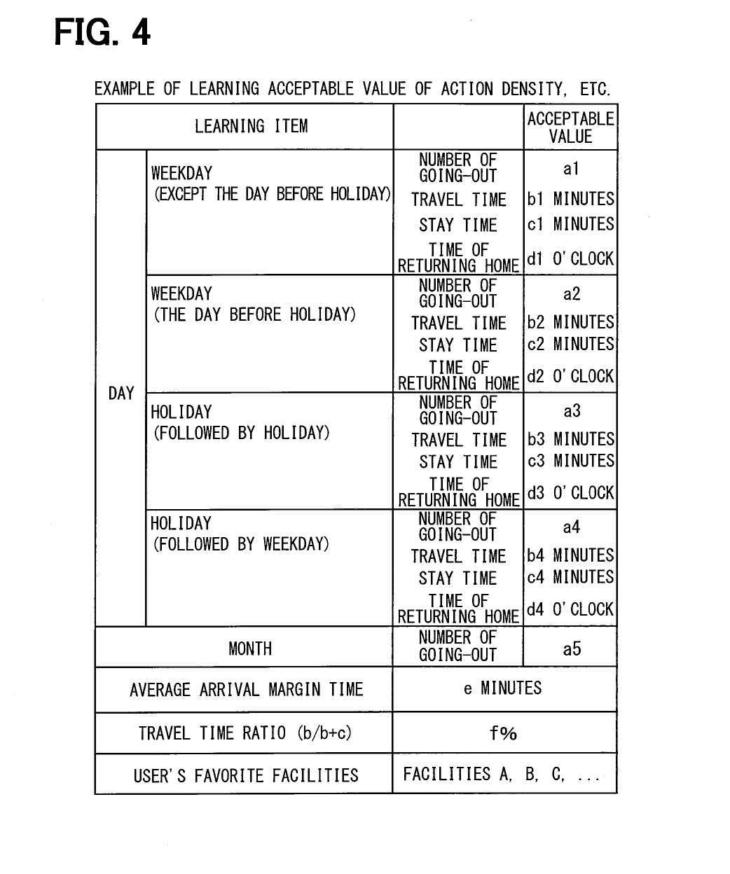

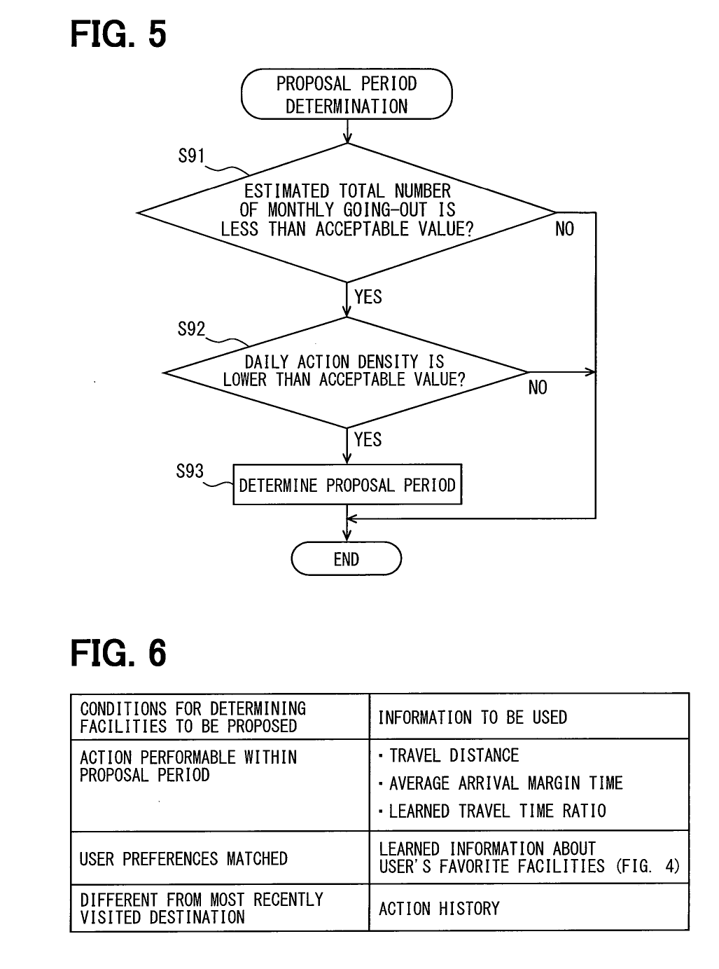

A predefined period of history is used to calculate the average value. One end of the period is the present time. In other words, the acceptable value is set by using the history of the predefined period including the most recent past. FIG. 4 illustrates an example of learning the acceptable value of action density.

In the example of FIG. 4, a daily acceptable value of each of the number of going-outs, the travel time, the stay time, and the time of returning home is learned while the days of a week are divided into four categories, namely, (1) a weekday except a day before a holiday, (2) a weekday before a holiday, (3) a holiday followed by another holiday, and (4) a holiday followed by a weekday. In this example, as for the number of going-outs, a monthly acceptable value is also learned.

In step S5, the action information about the user except an acceptable value is updated based on the action history. As illustrated in FIG. 4, the action information includes an average arrival margin time. The average arrival margin time is the average time difference between scheduled arrival time and actual arrival time. The scheduled arrival time is the time of arrival at a destination written in a previously acquired schedule.

In step S5, a travel time ratio is also learned. The travel time ratio is determined by dividing the travel time by the sum of the travel time and stay time. In the example of FIG. 4, the travel time ratio is calculated without distinguishing categories (1) to (4) from each other. However, the travel time ratio may be calculated for each category of (1) to (4). In step S5, the user's favorite facilities are additionally learned. The period of action history used for learning in step S5 is the same as the one in step S4.

Steps S6 and S7 are performed by the available time acquisition unit 63. In step S6, a future schedule of the user is acquired. The period to be acquired is set to be equal to a period required for processing in step S9. In the present embodiment, it is assumed that the period to be acquired ends at the end of the next month. The reason is that an estimated total number of going-outs per month is to be calculated in later-described step S9. More specifically, the estimated total number of going-outs of both the present month and the next month is calculated in step S9.

The future schedule is acquired from the external information processing device. It is therefore preferred that the external information processing device be left connected for communication during the time interval between the execution of step S2 and the execution of step S6. An alternative is to keep the external information processing device connected at all times. The user's future schedule may be additionally acquired in step S2.

In step S7, available time in the future schedule acquired in step S6 is determined.

Subsequently, step S8 is performed by the density determination unit 64. Based on the action history updated in step S3 and the future schedule acquired in step S6, step S8 is performed to determine the action density of the user for a unit period including at least one available time slot determined in step S7.

The action density is represented, for example, by the number of going-outs. An actual specific action density corresponding to a specific action density whose acceptable value is determined in step S4 is determined. When the specific action density is to be determined, a period corresponding to a unit period (for example, one day) for the acceptable value is used as a unit. Therefore, the number of going-outs, the travel time, the stay time, and the time of returning home are determined, for example, on a daily basis. Further, when the number of going-outs, the travel time, the stay time, and the time of returning home are determined, weekdays are divided into a weekday except the day before a holiday and a weekday before a holiday and holidays are divided into a holiday followed by another holiday and a holiday followed by a weekday, as is the case with the acceptable value. Besides, the number of going-outs is also determined on a monthly basis.

Subsequently, step S9 is performed by the proposal unit 65. In step S9, a proposal period is determined. The proposal period is a period for which an action proposal may be made, that is, an available period that may be filled with an action.

In step S9, a subroutine illustrated in FIG. 5 is executed. Step S91 of FIG. 5 is performed to determine whether or not the estimated total number of going-outs per month is smaller than an acceptable value. In the present embodiment, this determination is made for the present month and the next month. The estimated total number of going-outs of the present month includes the number of going-outs in the past portion of the present month.

When the estimated total number of going-outs of either the present month or the next month is smaller than the acceptable value, the determination result in step S91 is “YES.” When, in contrast, the estimated total number of going-outs of both the present month and the next month is equal to or greater than the acceptable value, the determination result in step S91 is “NO.” When the determination result in step S91 is “NO,” the process of FIG. 5 terminates. Thus, when the determination result in step S91 is “NO,” the determination of the proposal period will be canceled.

When the determination result in step S91 is “YES,” processing proceeds to step S92. Step S92 is performed to determine whether or not a daily action density is lower than an acceptable value. This determination is made for days of a month that is determined in step S91 to have an estimated total number of going-outs smaller than an acceptable value. Obviously, each month includes a plurality of days. The determination is made for at least the present day. The determination may be made for a plurality of days including the present day. An alternative is to start making the determination for the present day in step S92 and successively switch to the next day to make the determination until the determination result in step S92 is “YES.”

The action density checked in step S92 is represented by the number of going-outs, the travel time, the stay time, and the time of returning home, which are indicated in FIG. 4. When all of these four values are lower than acceptable values, the determination result in step S92 is “YES.” When the determination result in step S92 is “NO,” the process of FIG. 5 terminates as well. Thus, when the determination result in step S92 is “NO,” the determination of the proposal period will be canceled either.

When the determination result in step S92 is “YES,” processing proceeds to step S93. In step S93, the proposal period is determined. The proposal period is a part or the whole of available time included in a day for which the determination result in step S92 is “YES.” In a case where the proposal period is added, the resulting period is not allowed to exceed the associated acceptable value.

Upon completion of step S93, processing returns to FIG. 2 in order to perform step S10. Step S10 is performed by the proposal unit 65.

In step S10, the action to propose is determined. The present embodiment is the navigation device 1 and designed to propose a going-out or a visit to a destination as the action to propose. Thus, the action in the present embodiment is a travel.

In the present embodiment, the facility to propose is determined under the conditions indicated in FIG. 6. As illustrated in FIG. 6, a first condition for determining the facility to propose is that an action should be completed within the proposal period. Whether the action can be completed within the proposal period is determined by using a travel distance, average arrival margin time, and travel time ratio as indicated in FIG. 6 in addition to the proposal period determined in step S9.

Specifically, the travel distance is a sum of the distance from reference place to a facility and a distance from the facility to the next destination. These distance values are used to calculate the time of traveling to the facility and the time of traveling from the facility to the next destination. A reference place of departure to the place of the facility is the immediately preceding place to stay that is indicated in a plan. For example, the user's home or company is the place of departure. The next destination is, for example, the user's home. When the next destination to reach after the end of the proposal period is already indicated in the plan, the average arrival margin time is taken into consideration. More specifically, a check is performed to determine whether the proposal action can be completed within a period that is obtained by subtracting the average arrival margin time from the proposal period.

The condition is not established when the sum of the time of travel to the facility and the time of travel from the facility to the next destination is longer than the proposal period (or a period obtained by subtracting the average arrival margin time from the proposal period).

Further, the travel time ratio is calculated by dividing the travel time calculated from the travel distance by the proposal period. The calculated travel time ratio is then compared against the learned travel time ratio. When the calculated travel time ratio is higher than the learned travel time ratio by more than a predetermined value, it is conceivable that the calculated travel time ratio is not acceptable by the user. Hence, the condition is not established either when the calculated travel time ratio is higher than the learned travel time ratio by more than the predetermined value.

A second condition for determining the facility to propose is that the facility to propose should match user preferences. For this determination, the user's favorite facilities learned as indicated in FIG. 4 are used.

A third condition for determining the facility to propose is that the destination should not coincide with a destination selected for the most recent period of exclusion. The length of the period of exclusion is predefined to be, for example, one month prior to the present time. The destinations are determined to be different from each other as far as they represent different facilities even when the destinations are of the same genre. For determination of this condition, the action history is used. Under this condition, only one facility or a plurality of facilities may be determined as the facility to be proposed to the user.

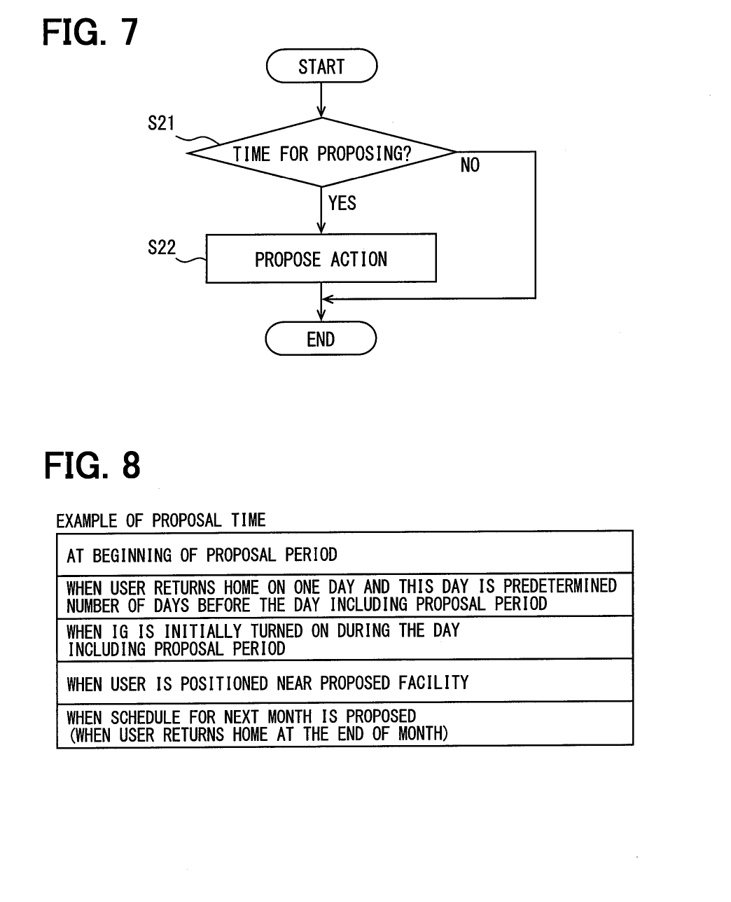

The content of the proposal, that is, the proposal period and the travel to the destination, which is a proposed action, is determined in the above manner, and the process of FIG. 2 is ended. After the process of FIG. 2 is performed to determine the content of the proposal, the process of FIG. 7 is performed.

The process of FIG. 7 is performed at fixed intervals. The process of FIG. 7 is also performed by the proposal unit 65. In step S21, a check is performed to determine whether the time for proposing has arrived.

The time for proposing may be determined in advance. For example, the time for proposing may be the beginning of a proposal period as illustrated in FIG. 8. Further, the time for proposing may also precede a start point of the proposal period as described below. For example, the time for proposing may be predetermined to be the time at which the user returns home on one day that is a predetermined number of days before the day including the proposal period. For example, the time for proposing may be predetermined to be the time at which the ignition switch is turned on for the first time in a day including the proposal period. For example, the time for proposing may be predetermined to be the time at which the user is near a proposed facility. For example, the time for proposing may be predetermined to be the time at which the schedule for the next month is proposed. The time at which the schedule for the next month is proposed is, for example, the time at which the user comes home on one day at the end of a month.

When the determination result in step S21 is “NO,” the process of FIG. 7 terminates. When, in contrast, the determination result in step S21 is “YES,” processing proceeds to step S22. Step S22 is performed to propose an action that is determined by the process of FIG. 2.

The present embodiment, which has been described above, acquires the future available time of the user (S6, S7), but does not always make an action proposal for the available time. The present embodiment learns the acceptable value of the user's action density (S4) and compares the learned acceptable value of the action density against the user's action density for the unit period (one day or one month) including the acquired available time (S91, S92). The result of the comparison is used to determine whether the available time should be filled with proposed actions (S93).

Hence, when an action density of the schedules exceeds the acceptable value of the user's action density after the available time is filled with a proposed action, the present embodiment determines that the available time should not be filled with the proposal action. When, in contrast, the action density of the schedules does not exceed the acceptable value of the user's action density after the available time is filled with the proposed action, the present embodiment determines that the available time can be filled with the proposed action (handled as a proposal period) (S91-S93), and proposes the action that can be performed during the proposal period to the user (S22). This configuration makes it possible to propose an action appropriate for the pace of the user.

An embodiment of the present disclosure has been described. However, the present disclosure is not limited to the foregoing embodiment, which has been described above. The following embodiments are also included in the technical scope of the present disclosure. Further, the following embodiments may be variously modified without departing from the spirit of the present disclosure.

(First Modification)

The foregoing embodiment calculates the action density for a unit period of one month. The unit period includes available time and the available time includes a time available in the past and a time available in the future. However, the present disclosure is not limited to such a calculation. An alternative is to handle an available time slot in the future as an end point of the calculation object period to calculate the action density and calculate the action density for only the period before the end point. When this alternative scheme is used, it is possible to avoid proposing an action to be performed during an available time slot, which has been intentionally set by the user in order to take a rest after a prolonged busy period on purpose. In this alternative case, too, the length of the period is the same as the unit period for the acceptable value of action density.

(Second Modification)

In contrast to the first modification, an available time slot in the future may alternatively be handled as a start point of the calculation object period to calculate the action density and the calculation object period may continue for a predetermined period after the start point. When this alternative scheme is used, it is possible to avoid proposing an action to be performed during an available time slot, which has been set in consideration of a future plan. In this alternative case, too, the length of the period is the same as the unit period for the acceptable value of action density.

(Third Modification)

One or more of the four specific daily action densities mentioned in conjunction with the foregoing embodiment, namely, the number of going-outs, the travel time, the stay time, and the time of returning home, may be left unused. Further, the monthly action density, namely, the number of going-outs per month, may be left unused.

(Fourth Modification)

An alternative is to learn the acceptable value of the number of side trips during a going-out in addition to or in place of the acceptable values for the specific action densities mentioned in conjunction with the foregoing embodiment and propose an action including a side trip during a going-out.

(Fifth Modification)

In the foregoing embodiment, an action density calculation period, such as the present month or the next month, is on a monthly basis of a calendar. However, the present disclosure is not limited to such an action density calculation period. For example, the action density may alternatively be calculated on a four-week basis involving two weeks before and after the present time. Another alternative is to calculate the action density for a period other than one month, such as a period of two weeks.

(Sixth Modification)

In the foregoing embodiment, the navigation device 1 functions as the action proposal device. Alternatively, a smartphone or other mobile information processing device or a personal computer may function as the action proposal device.

(Seventh Modification)

An alternative is to propose an action that does not include traveling or a movement. Alternatively, an action including a movement but not including an explicit destination only with a purpose (for example, in order to enjoy sports) can be proposed to the user.

(Eighth Modification)

In the foregoing embodiment, the density determination unit 64 handles the number of going-outs, the travel time, the stay time, and the time of returning home as the action densities. Alternatively, the degree of schedule tightness may be handled as an action density. For example, the ratio of shaded portions to the entire action history or schedule exemplified in FIG. 3 may be handled as the action density.

The eighth modification is substantially the same as the foregoing embodiment except that the degree of schedule tightness is handled as an action density. The eighth modification is summarized below.

The learning unit 62 determines the acceptable value of the degree of schedule tightness by learning. The available time acquisition unit 63 acquires the future available time in a schedule. The proposal unit 65 then compares the degree of schedule tightness acquired by the available time acquisition unit 63 against the acceptable value of the degree of schedule tightness, which is learned by the learning unit 62. When the result of comparison does not indicate that the learned degree of schedule tightness is exceeded by the acquired degree of schedule tightness, the proposal unit 65 determines that a plan may be formed for the available time in the schedule, which is acquired by the available time acquisition unit 63. Further, the proposal unit 65 makes this determination in such a manner that the acceptable value of the degree of schedule tightness is not exceeded when the available time is filled. The proposal unit 65 then proposes an action, which can be performed within the determined available time, at a time described in conjunction with the foregoing embodiment.

While the present disclosure has been described in conjunction with the foregoing embodiment, it is to be understood that the present disclosure is not limited to the foregoing embodiment or its construction. The present disclosure is intended to cover various modifications and equivalent arrangements. In addition, various combinations and configurations, and other combinations and configurations obtained by adding only one element or more or fewer elements to the various combinations and configurations are also within the spirit and scope of the present disclosure.

What is claimed is:

1. An action proposal device comprising:
a learning unit learning an acceptable value of an action density of a user based on a past schedule of the user;
an available time acquisition unit acquiring an available time of the user in future;
a density determination unit determining an action density of the user for a predetermined period including the available time acquired by the available time acquisition unit; and
a proposal unit comparing the action density determined by the density determination unit with the acceptable value of the action density, which is learned by the learning unit, and the proposal unit determining, corresponding to a comparison result, whether to perform an action proposal for the available time acquired by the available time acquisition unit, wherein, when the proposal unit determines to perform the action proposal for the available time, the proposal unit proposes an action that is finishable during the available time of the user.

2. The action proposal device according to claim 1, wherein
the density determination unit determines the action density of the user for the predetermined period and the predetermined period further includes a segment of past time in addition to the available time acquired by the available time acquisition unit.

3. The action proposal device according to claim 1, wherein,
the action proposed by the proposal unit includes a going-out, and
the learning unit learns an acceptable value of a total number of going-outs as the acceptable value of the action density of the user.

4. The action proposal device according to claim 1, wherein
the action proposed by the proposal unit includes a travel, and
the learning unit learns an acceptable value of a required time for the travel as the acceptable value of the action density of the user.

5. The action proposal device according to claim 1, wherein
the action proposed by the proposal unit includes a going-out, and
the learning unit learns an acceptable value of a time at which the user returns home as the acceptable value of the action density of the user.

6. The action proposal device according to claim 1, wherein
the action proposed by the proposal unit includes a side trip performed during a going-out, and
the learning unit learns an acceptable value of a total number of side trips during the going-out as the acceptable value of the action density of the user.

7. The action proposal device according to claim 1, wherein
the learning unit calculates an average time difference between a scheduled time of arrival at a destination defined in a schedule of the user and an actual time of arrival at the destination, and
the proposal unit proposes, to the user, the action that is finishable during a period obtained by subtracting the average time difference from the available time of the user.

8. The action proposal device according to claim 1, wherein
the learning unit learns an acceptable value of a degree of schedule tightness acceptable by the user as the acceptable value of the action density of the user,
the available time acquisition unit acquires the available time included in a future schedule of the user,
the density determination unit determines a degree of schedule tightness of the user for a predetermined period including the available time acquired by the available time acquisition unit as the action density of the user for the predetermined period, and
the proposal unit compares the acceptable value of the degree of schedule tightness, which is learned by the learning unit, with the degree of schedule tightness of the user for the predetermined period, which is determined by the density determination unit, the proposal unit determines, based on a comparison result, whether to perform a plan setting for the available time acquired by the available time acquisition unit, and when the proposal unit determines to perform the plan setting for the available time, the proposal unit proposes a plan that is finishable during the available time of the user.

9. The action proposal device according to claim 1, wherein
the learning unit distinguishes weekdays from holidays when learning the acceptable value of the action density of the user.

10. The action proposal device according to claim 9, wherein
the learning unit distinguishes a weekday before a holiday from remaining weekdays when learning the acceptable value of the action density of the user.

11. The action proposal device according to claim 9, wherein
the learning unit distinguishes a holiday before a weekday from remaining holidays when learning the acceptable value of the action density of the user.

12. The action proposal device according to claim 1, wherein
the proposal unit proposes the action which is different from an action performed by the user during an exclusion period, which is preselected as a most recent past period from a present time.
